(19) United States
(12) Patent Application Publication
(10) Pub. No.: US 2008/0080021 A1
(43) Pub. Date: Apr. 3, 2008

(54) Video output apparatus and display apparatus

(75) Inventor: Hideki Ohkita, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/785,197

(22) Filed: Apr. 16, 2007

(30) Foreign Application Priority Data
Sep. 29, 2006 (JP) 2006-0269790

(51) Int. Cl. H04N 1/04

(52) U.S. Cl. 358/479

(57) ABSTRACT

According to one embodiment, a display device for communicating with a video output device, comprising a control signal receiving portion that receives a list of screens from the video output device as a first control command, a displaying portion that displays the list of screens, a control signal transmitting portion that transmits a request to output at least one screen selected from the list of screens as a second control command, and a video signal inputting portion that receives at least one screen as a video signal.

### CROSS-REFERENCE TO RELATED APPLICATIONS

This application is based upon and claims the benefit of priority from Japanese Patent Application No. 2006-269790, filed Sep. 29, 2006, the entire contents of which are incorporated herein by reference.

### BACKGROUND

1. Field

One embodiment of the present invention relates to a video output device for outputting a video signal, and a display device for displaying a video.

2. Description of the Related Art

As the interface between the video output device and the display device, and the like, HDMI (High-Definition Multimedia Interface) is now spreading. The information of HDMI is disclosed by following Non-Patent document.
[Non-Patent Literature 1] Hitachi, Ltd. and six others, “High-Definition Multimedia Interface Specification Version 1.3”, [online], Jun. 22, 2006, HDMI Licensing, LLC, [Sep. 23, 2006 searched], Internet (URL:http://www.hdmi.org/)

In HDMI, the control device signal and the control protocol called CEC (Consumer Electronics Control) are standardized to control respective devices mutually.

In particular, in HDMI CEC, the function called Device Menu Control is stipulated. In Device Menu Control, switching of the display/hiding of the menu screen of the controlled device from TV and operation commands on the menu screen are defined.

However, in Device Menu Control of HDMI CEC in the prior art, when the controlled device is equipped with a plurality of menu screens, the user cannot select the menu screen that should be displayed from them. As a result, first the user has to display a desired menu screen by using the remote-controller, or the like of the video output device as the controlled device and then has to shift the remote-controller from the video output device to the display device to control the video output device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a configuration of a communication system in which a video output device and a display device according to Embodiment 1 of the present invention.

FIG. 2 is an exemplary block diagram showing a schematic configuration of the video output device according to Embodiment 1 of the present invention.

FIG. 3 is an exemplary block diagram showing a schematic configuration of the display device according to Embodiment 1 of the present invention.

FIG. 4 is an exemplary view explaining processes in an operation of selecting a menu screen of the communication system according to Embodiment 1 of the present invention.

FIG. 5 is an exemplary view showing an example of the control command output from a control system according to Embodiment 1 of the present invention transmits.

FIG. 6 is an exemplary view showing an example of the control command output from the video output device according to Embodiment 1 of the present invention transmits.

FIG. 7 is an exemplary view showing a display screen according to Embodiment 1 of the present invention displays.

FIG. 8 is an exemplary view showing the control command output from the display device according to Embodiment 1 of the present invention transmits.

FIG. 9 is an exemplary flowchart showing a flow of process in the display device according to Embodiment 1 of the present invention.

FIG. 10 is an exemplary flowchart showing an operation of the video output device according to Embodiment 1 of the present invention.

FIG. 11 is an exemplary view showing an outer appearance of a remote controller of a display device according to Embodiment 2 of the present invention.

FIG. 12 is an exemplary flowchart showing a flow of process in the display device according to Embodiment 2 of the present invention.

FIG. 13 is an exemplary view showing an example of a display screen that the display device according to Embodiment 2 of the present invention displays.

### DETAILED DESCRIPTION

Various embodiments according to the invention will be described hereinafter with reference to the accompanying drawings. In general, according to one embodiment of the invention, a display device for communicating with a video output device, comprising a control signal receiving portion that receives a list of screens from the video output device as a first control command, a displaying portion that displays the list of screens, a control signal transmitting portion that transmits a request to output at least one screen selected from the list of screens as a second control command, and a video signal inputting portion that receives at least one screen as a video signal.

A video output device and a display device of the present invention will be explained with reference to the drawings hereinafter.

### Embodiment 1

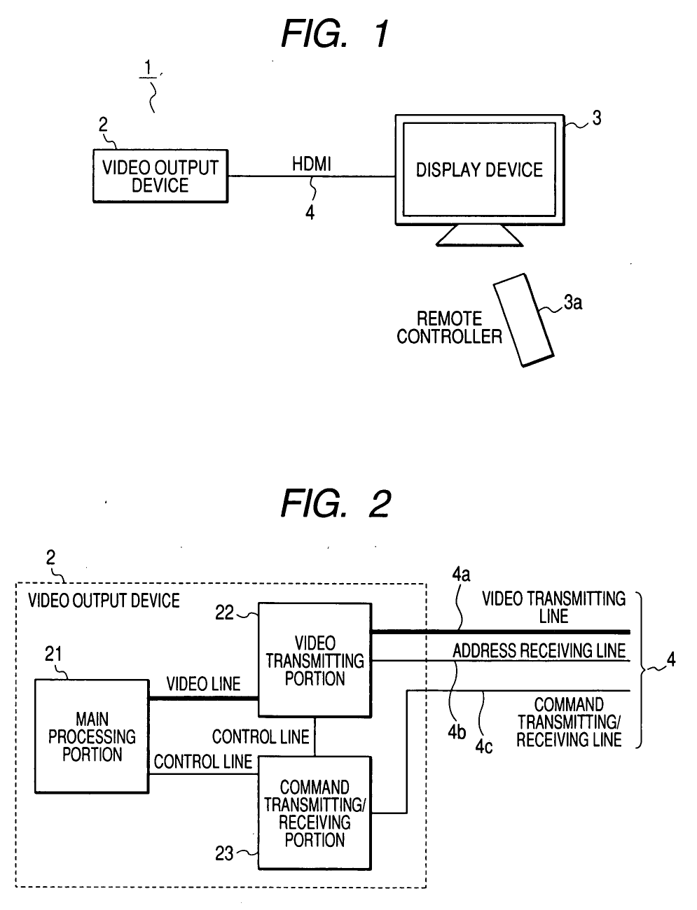

FIG. 1 is a view showing a configuration of a communication system in which a video output device and a display device according to Embodiment 1 of the present invention. A communication system 1 is constructed by a video output device 2 and a display device 3, and both devices are connected by a HDMI signal line 4.

The video output device 2 is the DVD (Digital Versatile Disk) player, the set-top box (STB), the recording/playing equipment, or the like, for example. The display device 3 is the digital television, for example. It is assumed that both devices have the HDMI terminal respectively.

The video output device 2 outputs data stored in the memory medium such as DVD, or the like, and video signals and sound signals obtained from the broadcast wave being input from an antenna to the display device 3 via the HDMI signal line 4. The display device 3 can display the video that is output from the video output device 2.

Also, the display device 3 can receive an operation signal from a remote controller 3a that the user operates. Then, the display device 3 can send the control command stipulated by HDMI CEC (referred simply to as “CEC” hereinafter) to the video output device 2 based on the operation signal command, and thus can perform various controls, e.g., cause the video output device 2 to output the menu screen. It is assumed herein that the video output device 2 can output a plurality of menu screens.

In the present embodiment, the remote controller 3a provided separately from the display device 3 is used as the input interface that the user operates to input the operation signal, but the input interface is not limited to this mode. For example, operation buttons provided to a main body of the display device 3 may be used as the input interface.

FIG. 2 is a block diagram showing a schematic configuration of the video output device 2 in the present embodiment. The video output device 2 is constructed by a main processing portion 21, a video transmitting portion 22, and a command transmitting/receiving portion 23. The main processing portion 21, the video transmitting portion 22, and the command transmitting/receiving portion 23 are connected via a control line (I2C Bus) respectively.

The main processing portion 21 has a function of outputting the video signal and the sound signal obtained by reproducing the data recorded on the memory medium (not shown) or the menu screen superimposed on the video signal, for example, to the video transmitting portion 22 via the video line.

Also, the main processing portion 21 controls the transmission/reception of the control command of the command transmitting/receiving portion 23 to/from the display device 3.

The video signal processed by the main processing portion 21 is input into the video transmitting portion 22 via the video line, as described above, and then output to the display device 3 from a video transmitting line 4a constituting the HDMI signal line 4 (TMDS: Transition Minimized Differential Signalizing)

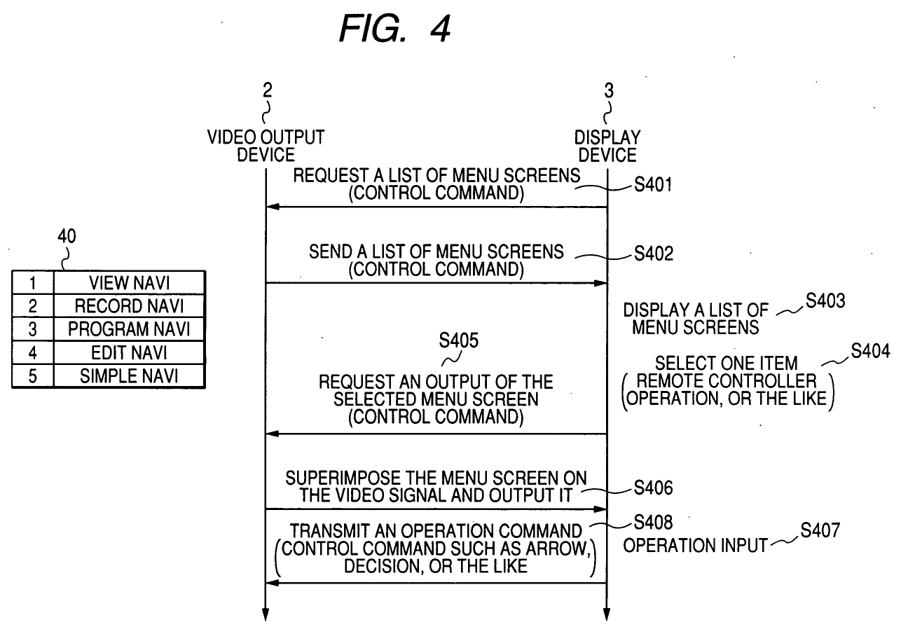

The command transmitting/receiving portion 23 transmits/receives the control command of CEC via an command transmitting/receiving line 4c constituting the HDMI signal line 4 under control of the main processing portion 21, as described above. In particular, the command transmitting/receiving portion 23 has a function of transmitting a list of menu screens that this portion can output for itself as the control command. Details will be described later with reference to FIG. 4, and the like.

Also, physical addresses necessary for the transmission of the video signal and the transmission/reception of the control command are decided via an address receiving line 4b constituting the HDMI signal line 4.

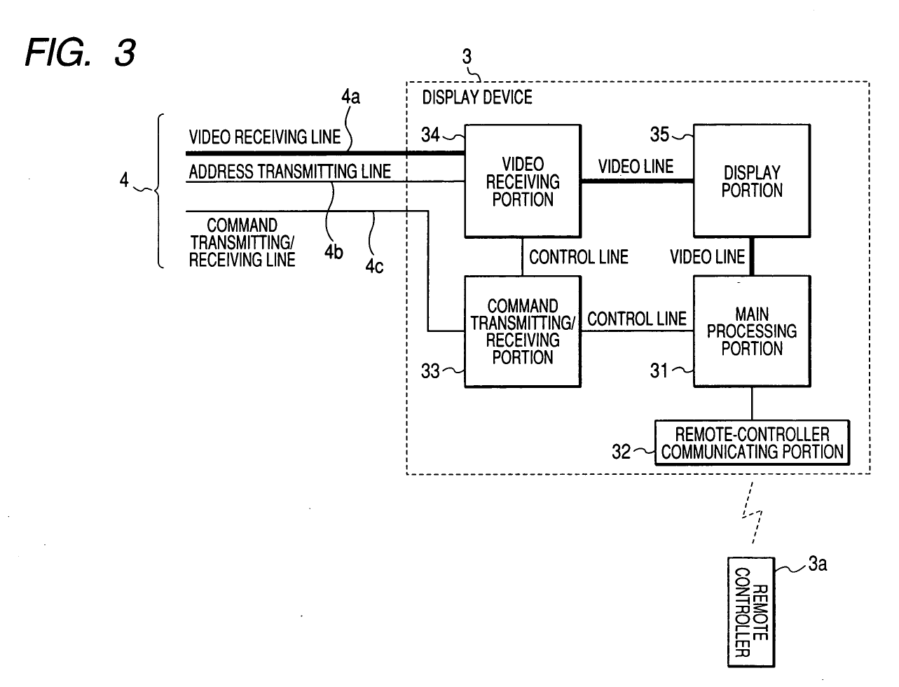

FIG. 3 is a block diagram showing a schematic configuration of the display device 3 in the present embodiment. The display device 3 is constructed by a main processing portion 31, a remote-controller communicating portion 32, a command transmitting/receiving portion 33, a video receiving portion 34, and a displaying portion 35. The main processing portion 31, the command transmitting/receiving portion 33, and the video receiving portion 34 are connected via the control line (I2C Bus).

The main processing portion 31 controls the transmission/reception of the control command of the command transmitting/receiving portion 33 to/from the video output device 2. In particular, the main processing portion 31 causes the command transmitting/receiving portion 33 to transmit the control command based on the operation signal that the remote-controller communicating portion 32 received from the remote controller 3a, as occasion demands.

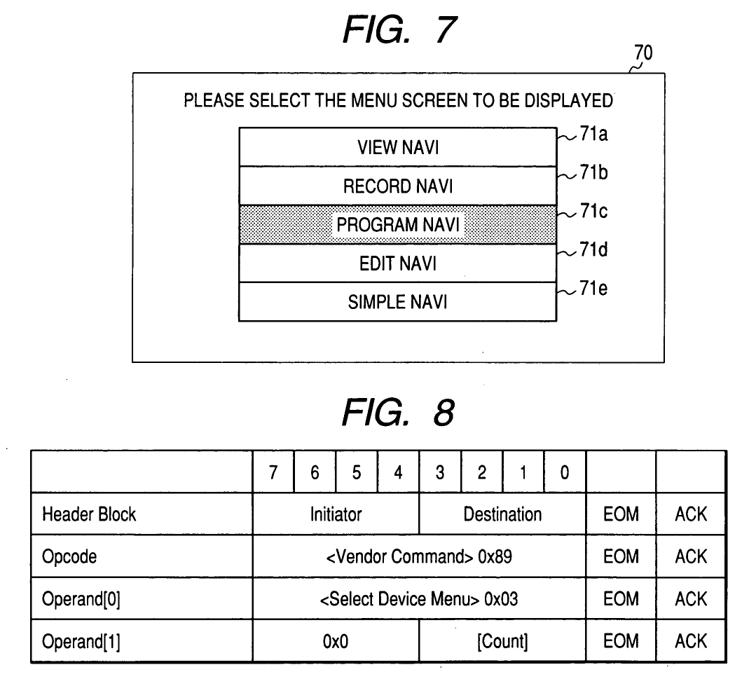

Also, the main processing portion 31 can form a list display screen of menu screens based on list information of menu screens that this portion received from the video output device 2 as the control command, and then cause the displaying portion 35 to display such screen. This display screen will be described later with reference to FIG. 7.

The command transmitting/receiving portion 33 transmits/receives the control command of CEC via the command transmitting/receiving line 4c constituting the HDMI signal line 4 under control of the main processing portion 31. In particular, this command transmitting/receiving portion 33 can transmit a request to send a list of menu screens that the video output device 2 can output or a request to output one menu screen among the menu screens that the video output device 2 can output, as the control command.

Also, the main processing portion 31 performs the control of the video receiving portion 34 via the command transmitting/receiving portion 33. The video signal being input into the video receiving portion 34 via the video receiving line 4a constituting the HDMI signal line 4 (explained as the video transmitting line 4a in FIG. 2) is sent to the displaying portion 35 via the video line, and the displaying portion 35 displays this video signal. The main processing portion 31 may be connected to the display portion via the video line.

The physical addresses necessary for the reception of the video signal and the transmission/reception of the control command are decided via the address transmitting line 4b constituting the HDMI signal line 4 (explained as the address receiving line 4b in FIG. 2).

Next, an example of an operation of selecting a menu screen in the present communication system 1 will be explained with reference to FIG. 4 hereunder.

First, the display device 3 requests the video output device 2 from the command transmitting/receiving portion 33 to send a list of menu screens (S401).

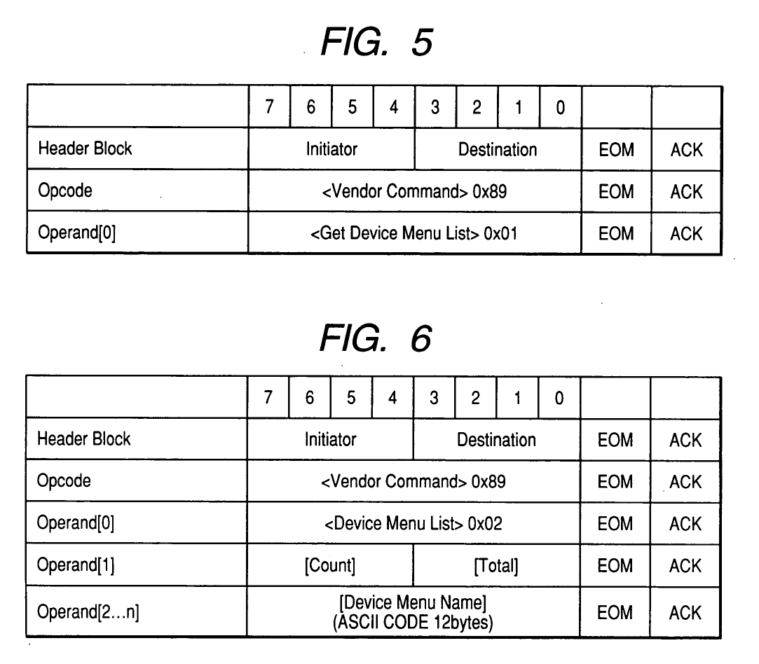

FIG. 5 is a view showing an example of the control command used to request a list of menu screens. A logical address of the display device 3 used to transmit the control command is set to 4 bits of “Initiator”, and a logical address of the video output device 2 as a demandant of the list of menu screens is set to 4 bits of “Destination”.

In addition, the value “0×89” indicating Vendor Command is set to 8 bits of “Opcode”, and the code “0×01” allocated previously to the request for the list of menu screens (given as “Get Device Menu List” in the example in FIG. 5) is set to 8 bits of “Operand [0]”.

In this case, the code allocated to the request for the list of menu screens is not limited to “0×01” (this is similarly true of the control commands in FIG. 6 and FIG. 8).

When the video output device 2 receives the control command (FIG. 5) that requests a list of menu screens at the command transmitting/receiving portion 23, this command transmitting/receiving portion 23 sends a list of menu screens to the display device 3 as the control command in answer to this control command (S402).

FIG. 6 is a view showing an example of the control command that the video output device 2 transmits as a response to the request for a list of menu screens. A logical address of the video output device 2 that sends out this control command is set to 4 bits of “Initiator”, and a logical address of the display device 3 as the destination of a list of menu screens is set to 4 bits of “Destination”.

In addition, the value ”0×89” indicating Vendor Command is set to 8 bits of “Opcode”, and the code “0×02” allocated previously to the response to the request for a list of menu screens (given as “Device Menu List” in the example in FIG. 6) is set to 8 bits of “Operand [0]”.

This control command is transmitted as many as the number of times indicated in [Total] (4 bits, supposed as “m” herein). In this case, it is supposed that the ID value (1≦x≦m) used to identify each menu screen is set to [Count] (4 bits, supposed as “x” herein), and the characters as the menu name corresponding to ID is set to [Device Menu Name] subsequent to Operand [2] in ASCII CODE.

In the example of a menu screen list 40 in FIG. 4, the video output device 2 can output five types of menu screens in total, i.e., “view navi” (ID: 1), “record navi” (ID: 2), “program navi” (ID: 3), “edit navi” (ID: 4), and “simple navi” (ID: 5).

Therefore, the control command shown in FIG. 6 is sent out five times in total (i.e., the value of [Total] is 5). The characters of [Device menu Name] in the control command whose [Count] value is 1 corresponds to “view navi”, the characters of [Device menu Name] in the control command whose [Count] value is 2 corresponds to “record navi”, the characters of [Device menu Name] in the control command whose [Count] value is 3 corresponds to “program navi”, the characters of [Device menu Name] in the control command whose [Count] value is 4 corresponds to “edit navi”, and the characters of [Device menu Name] in the control command whose [Count] value is 5 corresponds to “simple navi”.

When the display device 3 receives all control commands (five in the example in FIG. 4) indicating the menu screen list shown in FIG. 6 as an example respectively, such display device 3 forms a menu list screen showing a list of received menu screens to offer the user this screen and calls upon the user to select the menu screen (S403).

FIG. 7 is a view showing an example of the menu list screen that the main processing portion 31 of the display device 3 forms and causes the displaying portion 35 to display. In this example, icons 71a to 71e labeled “view navi”, “record navi”, “program navi”, “edit navi”, and “simple navi” respectively are displayed on a menu list screen 70 such that the user can select any icon by operating the remote controller 3a. In the example in FIG. 7, the icon 71c indicating “program navi” is selected.

The user selects one of icons on the menu list screen 70 by operating the remote controller 3a as the input interface (S404). Then, the command transmitting/receiving portion 33 of the display device 3 requests the video output device 2 to output the selected menu screen (S405).

FIG. 8 is a view showing an example of the control command that the display device 3 transmits to request an output of the menu screen. A logical address of the display device 3 that transmits this control command is set to 4 bits of “Initiator”, and a logical address of the video output device 2 as the destination of the control command is set to 4 bits of “Destination”.

In addition, the value “0×89” indicating Vendor Command is set to 8 bits of “Opcode”, and the code “0×03” allocated previously to the request to output the menu screen (given as “Select Device Menu” in the example in FIG. 8) is set to 8 bits of “Operand [0]”.

In addition, ID of the menu screen requested to be output is set to 4 bits of [Count] of Operand [1]. For example, when the user selects “program navi” as shown in FIG. 7, “3” corresponding, to ID of “program navi” is set to, [Count].

The main processing portion 21 of the video output device 2 superimposes the menu screen on the video signal in compliance with the request, and transmits this menu screen from the video transmitting portion 22 to the display device 3 via the video transmitting line 4a (S406).

Then, the display device 3 responds to the operation input that is issued from the user and received at the remote-controller communicating portion 32 as the operation signal (S407). Thus, the display device 3 transmits the operation command from the command transmitting/receiving portion 33 to the video output device 2 via the command transmitting/receiving line 4c to control the video output device 2 at need (S408).

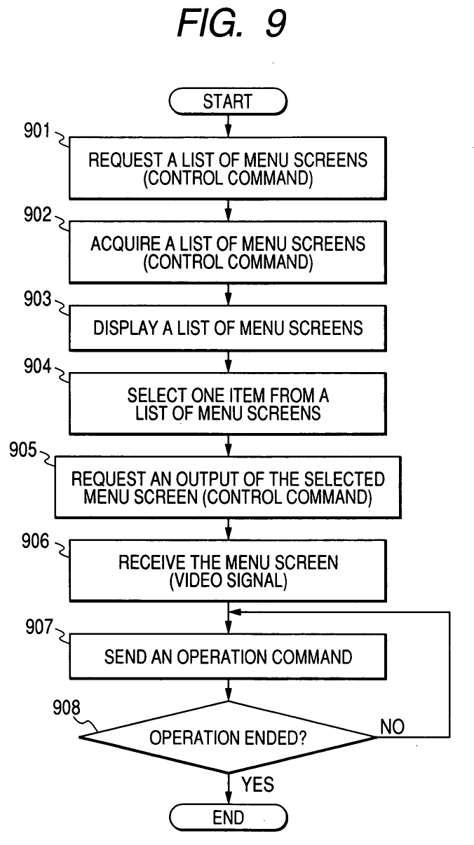

FIG. 9 is a flowchart showing an operation of the display device 3 in the present embodiment.

First, the command transmitting/receiving portion 33 of the display device 3 transmits the control command, which requests a list of menu screens and shown in FIG. 5 by way of example, to the video output device 2 (S901).

In response to this request, the display device 3 receives a list of menu screens from the video output device 2 at the command transmitting/receiving portion 33 as the control command an example of which is shown in FIG. 6 (S902). The main processing portion 31 forms a list screen of menu screens shown in FIG. 7 as an example, and causes the displaying portion 35 to display the list and urges the user to select the menu screen (S903).

Then, the user selects one item by operating the remote controller 3a (S904). The command transmitting/receiving portion 33 transmits the control command, which requests an output of the selected menu screen and shown in FIG. 8 as an example, to the video output device 2 (S905).

Since the display device 3 superimposes the menu screen on the video signal in response to the request and outputs it, such display device 3 displays the image of the menu screen being input from the video receiving portion 34 on the displaying portion 35 (S906).

Then, the display device 3 checks the operation signal that is sent from the remote controller 3a and received at the remote-controller communicating portion 32 (S907). Then, a flow is ended if the operation is ended (Yes in S908), or the process goes back to S907 unless the operation is ended (No in S908).

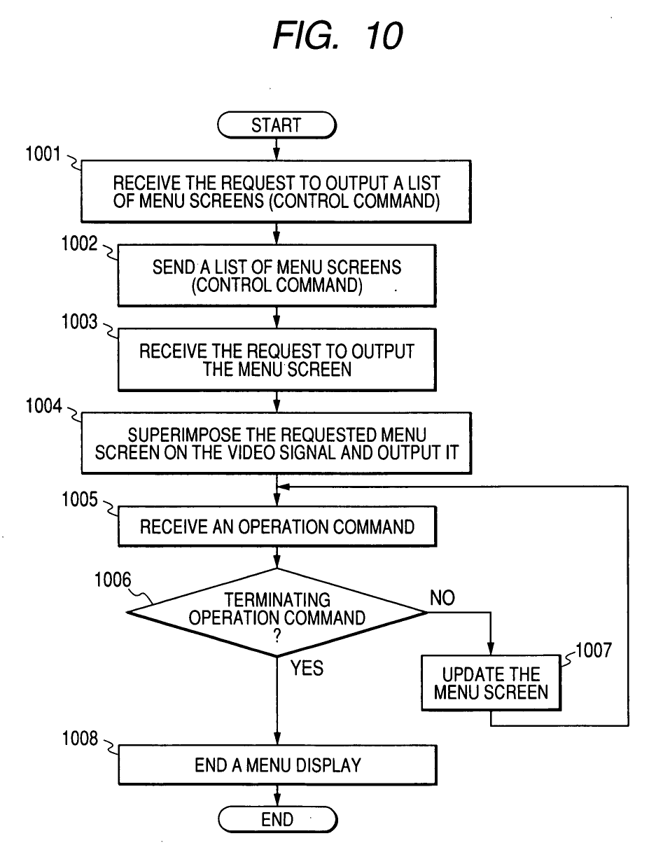

FIG. 10 is a flowchart showing an operation of the video output device 2 in the present embodiment.

First, the video output device 2 receives the control command, which requests a list of menu screens and shown in FIG. 5 as an example, via the command transmitting/receiving line 4c at the command transmitting/receiving portion 23. (S1001). In response to this request, the video output device 2 sends a list of outputtable menu screens from the command transmitting/receiving portion 23 as the control command that is shown in FIG. 6 by way of example (S1002).

Then, the video output device 2 receives the request to output the menu screen, which is shown in FIG. 8 as an example, at the command transmitting/receiving portion 23 (S1003). Then, the video output device 2 superimpose the selected menu screen on the video signal, and transmits such menu screen from the video transmitting portion 22 to the display device 3 (S1004).

Then, the video output device 2 receives the operation command (control command) at the command transmitting/receiving portion 23 (S1005), and then decides whether or not this control command is a terminating operation command (S1006). If the control command is not the terminating operation command (No in S1006), the video output device 2 updates the menu screen in response to the contents of the operation (S1007). Then, the process goes back to S1005. If the control command is the terminating operation command (Yes in S1007), the video output device 2 ends a menu display (S1008). Then, a flow is ended.

As described above, according to the present embodiment, even when the video output device 2 can output a plurality of menu screens, the user can operate the video output device 2 by causing the video output device 2 to output the selected menu screen by the operation of the remote controller 3a as the input interface of the display device 3, without use of the input interface such as the remote controller of the video output device 2, or the like.

### Embodiment 2

In Embodiment 1, a list screen of the menu screens is displayed on the displaying portion 35 of the display device 3, and the user is caused to select the menu screen. But the selecting mode is not limited to this mode. An embodiment in which respective menu screens are correlated with operation buttons will be explained hereunder.

The configuration and the operation of the video output device 2 and the display device 3 explained with reference to FIG. 1 to FIG. 3 are substantially similar to those in Embodiment 1, and their explanation will be omitted herein.

In this case, the main processing portion 31 in Embodiment 1 has the function of displaying a list of menu screens to cause the user to select the menu screen. However, alternately the main processing portion 31 in Embodiment 2 has a function of correlating the operation buttons provided to the remote controller 3a with respective menu screens that the video output device 2 outputs.

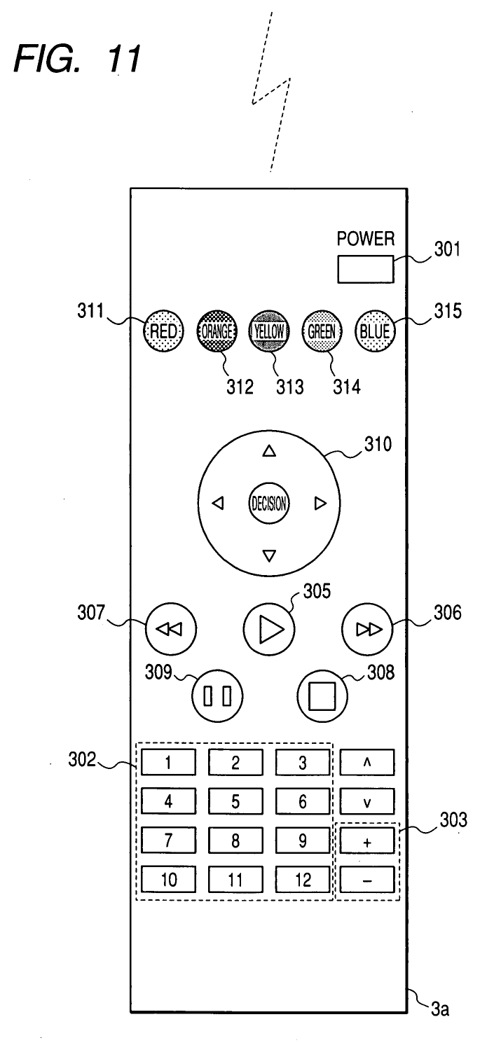

An example of the remote controller 3a as the input interface of the display device 3 is shown in FIG. 11.

The remote controller 3a has a power button 301, a channel button 302, a volume control button 303, and the like. Also, the remote controller 3a has a play button 305 used to control a playing process of the video output device 2 that plays the data stored in the memory medium such as DVD, HDD, or the like, a fast forward button 306, a rewind button 307, a stop button 308, and a pause button 309, for example.

In addition, the remote controller 3a has operation buttons 311 to 315 that are colored in red, orange, yellow, green, and blue respectively.

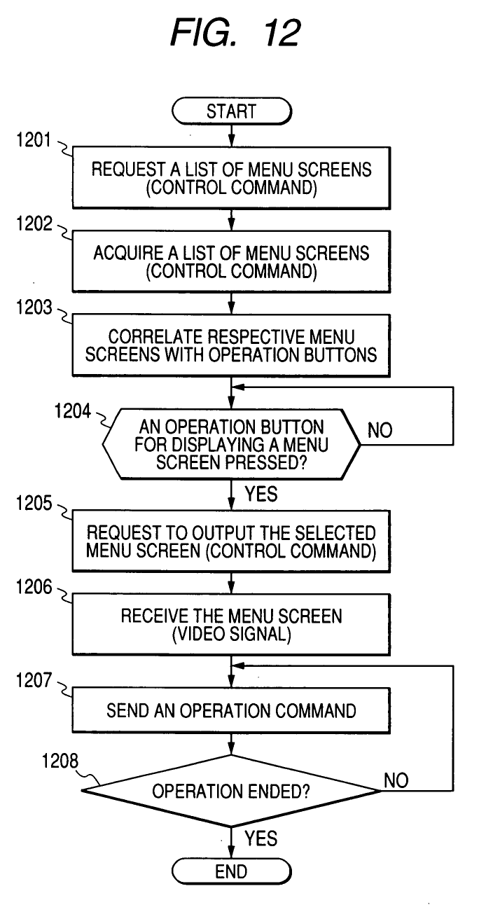

These operation buttons 311 to 315 can be correlated with the operation buttons that the video output device 2 can output on a one-to-one basis when the process shown in FIG. 12 is executed.

FIG. 12 is a flowchart showing an operation of the display device 3 in the present embodiment.

First, the command transmitting/receiving portion 33 of the display device 3 transmits the control command, which requests a list of menu screens and shown in FIG. 5 as an example, to the video output device 2 (S1201).

Then, the display device 3 receives the control command, which the video output device 2 transmits to show a list of menu screens shown in FIG. 6 by way of example, at the command transmitting/receiving portion 33 (S1202). The main processing portion 31 correlates respective menu screens with the operation buttons 311 to 315 of the remote controller 3a (S1203).

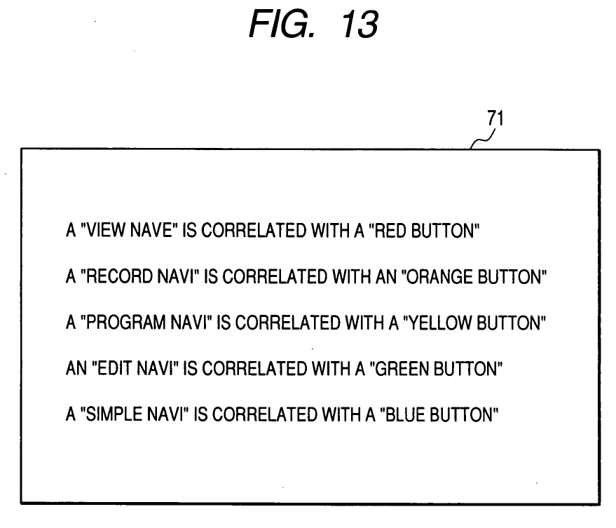

At this time, the main processing portion 31 may cause the displaying portion 35 to display correlated results. FIG. 13 shows an example of the display screen that the main processing portion 31 causes the displaying portion 35 to display.

A display screen in FIG. 13 can inform the user that a menu screen “view navi” is correlated with a red operation button 311, a menu screen “record navi” is correlated with an orange operation button 312, a menu screen “program navi” is correlated with a yellow operation button 313, a menu screen “edit navi” is correlated with a green operation button 314, and a menu screen “simple navi” is correlated with a blue operation button 315.

Then, if the user presses any of the operation button 311 to 315 to display the menu screen (Yes in S1204), the command transmitting/receiving portion 33 transmits the control command, which requests an output of the selected menu screen and shown in FIG. 8 as an example, to the video output device 2 (S1205).

Since the video output device 2 superimposes the menu screen on the video signal in answer to this request and outputs such menu screen, the display device 3 displays the image of the menu screen being input from the video receiving portion 34 on the displaying portion 35 (S1206).

In addition, the display device 3 checks the operation signal that is sent from the remote controller 3a and received by the remote-controller communicating portion 3 (S1207). Then, a flow is ended if the operation is ended (Yes in S1208), or the process goes back to S1207 unless the operation is ended (No in S1208).

As described above, according to the present embodiment, even when the video output device 2 can output a plurality of menu screens, the user can operate the video output device 2 by causing the video output device 2 to output the selected menu screen by the operation of the remote controller 3a as the input interface of the display device 3, without use of the input interface such as the remote controller of the video output device 2, or the like.

In addition, in the present embodiment, respective operation buttons are correlated with the menu screens that the video output device 2 outputs on a one-to-one basis. Therefore, the user can display a desired menu screen by one operation of the remote controller 3a.

As described with reference to the embodiment, there is provided a video output device and a display device capable of outputting a proper menu screen even when the video output device has a plurality of menu screens can be provided.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display device for communicating with a video output device, comprising:
a control signal receiving portion that receives a list of screens from the video output device as a first control command;
a displaying portion that displays the list of screens;
a control signal transmitting portion that transmits a request to output at least one screen selected from the list of screens as a second control command; and
a video signal inputting portion that receives at least one screen as a video signal.

2. The display device according to claim 1, wherein
the control signal receiving portion, the control signal transmitting portion, and the video signal inputting portion communicate with the video output device via HDMI (High-Definition Multimedia Interface); and
the first control command and the second control command are transmitted via an HDMI CEC (Consumer Electronics Control) signal line.

3. A display device for communicating with a video output device, comprising:
a remote-controller communicating portion that communicates with a remote controller having a plurality of operation buttons;
a control signal receiving portion that receives a list of screens from the video output device as a first control command;
a controlling portion that correlates each screen in the list of screen with respective one of the operation buttons;
a control signal transmitting portion that requests the video output device to output at least one of the screens as a second control command according to the remote controller;
a video signal inputting portion that receives at least one of the screens from the video output device as a video signal; and
a displaying portion that displays the screen based on the video signal received by the video signal inputting portion.

4. The display device according to claim 3, wherein
the control signal receiving portion, the control signal transmitting portion, and the video signal inputting portion communicate with the video output device via HDMI; and
the first control command and the second control command are transmitted via an HDMI CEC signal line.

5. A video output device, comprising:
a control signal transmitting portion that transmits a list of screens to a display device as a first control command;
a control signal receiving portion that receives a request to output at least one screen out of the list of screens from the display device as a second control command; and
a video signal outputting portion that outputs at least one screen as a video signal.

6. The video output device according to claim 5, wherein
the control signal transmitting portion, the control signal receiving portion, and the video signal outputting portion communicate with the display device via HDMI; and
the first control command and the second control command are transmitted via an HDMI CEC signal line.
